(19) United States
(12) Patent Application Publication
(10) Pub. No.: US 2008/0212459 A1
(43) Pub. Date: Sep. 4, 2008

(54) Method of Writing on an Optical Recording Medium, Optical Recording Medium, and Method of Manufacturing an Optical Recording Medium

(75) Inventors: Rudolf Johan Maria Vullers, Eindhoven (NL); Bart Van Rompaey, Eindhoven (NL); Andrei Mijiritskii, Zaltbommel (NL); Derk Jan Adelerhof, Eindhoven (NL); Antonius Emilius Theodorus Kuiper, Eindhoven (NL); Johannes Gerardus Fredericus Kablau, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/917,162

(22) PCT Filed: Jun. 9, 2006
(86) PCT No.: PCT/IB2006/051845

§ 371 Date: Dec. 11, 2007

(30) Foreign Application Priority Data
Jun. 15, 2005 (EP) 05105258.7

(51) Int. Cl. G11B 3/70

(52) U.S. Cl. 369/284

(57) ABSTRACT

The present invention relates to a method of writing information on an optical recording medium (10 to 38), the optical recording medium having at least one data layer (40) for storing data readable by use of an optical readout device and at least one label layer (42) for storing visible information, the method comprising the steps of: focusing a first wavelength laser beam (44 to 58) onto the at least one data layer for writing data on the data layer, and focusing a second wavelength laser beam (60 to 78) onto the at least one label layer for writing visible information on the label layer, thereby a laser spot size being usable that is also employable when using the second wavelength laser beam for writing data on a data layer for storing data readable by use of an optical readout device. The present invention further relates to an optical recording medium and to a method of manufacturing an optical recording medium.

### FIELD OF THE INVENTION

The present invention relates to a method of writing information on an optical recording medium, and in particular for writing labeling information on an optical recording medium. The present invention further relates to an optical recording medium on which labeling information can be written and to a method of manufacturing such an optical recording medium.

### BACKGROUND OF THE INVENTION

Methods of generating labels on an optical recording medium, like CD or DVD, are known. According to one of those methods, data readable by an optical readout device is recorded on one side of the disc, and then the disc is flipped manually in order for the label side to be printed. For label printing, infrared laser light is focused on the label side where, due to a significant amount of spherical aberration, a spot of about 20 μm is formed. With over 45 mW of power, dark concentric circles are written at densities varying from 175 TPI (tracks per inch) to 1200 TPI. Several problems are related to the known method:

As the linear writing speed is limited to 0.25 m/s, a complete label takes about 40 minutes to be written in the highest density mode. Even at a medium resolution of 600 TPI, a complete label takes 20 minutes to be written. Considering the time it takes to write the disc's data side (3 min for a CD at 52×, 9 min for a DVD at 8×) the label writing time appears as a major drawback. It is desired that label writing is at least as fast as data writing.

Further, due to the huge amount of spherical aberration in the spot that is focused on the label side, the focus S-curve in any of the known focus systems (Foucault, stigmatic) is completely distorted. Consequently, an open loop feed forward focus system is applied which needs frequent, time-consuming adjustments. It is not possible to use conventional focus servo loops.

Additional problems with the known concept relate to the manufacturing of the discs, particularly since the application of the label writing sensitive layer is done in a separate step.

It is therefore an object of the invention to provide a method of writing information on an optical recording medium, an optical recording medium and a method of manufacturing an optical recording medium, thereby avoiding the mentioned prior art problems, thus being able to write a label with high speed, making it possible to use a conventional servo system, and to facilitate the manufacturing of the disc.

### SUMMARY OF THE INVENTION

The above objects are solved by the features of the independent claims. Further developments and preferred embodiments of the invention are outlined in the dependent claims.

In accordance with the invention, there is provided a method of writing information on an optical recording medium, the optical recording medium having at least one data layer for storing data readable by use of an optical readout device and at least one label layer for storing visible information, the method comprising the steps of:

focusing a first wavelength laser beam onto the at least one data layer for writing data on the data layer, and

focusing a second wavelength laser beam onto the at least one label layer for writing visible information on the label layer, thereby a laser spot size being usable that is also employable when using the second wavelength laser beam for writing data on a data layer for storing data readable by use of an optical readout device.

Thus, in contrast to the mentioned prior art, a label writing with small aberration is provided. The label writing can be performed at least as fast as the data writing, conventional focus servo loops can be used, and the manufacturing of the optical recording medium is simplified.

According to a preferred embodiment, the first wavelength is different from the second wavelength. Thus, wavelengths used for different standards of optical recording can be used for writing data and labels, respectively.

It is also possible that the first wavelength and the second wavelength are identical. Thus, the same laser and, preferably, the same optics can be used for writing data and labels.

According to one basic concept of the present invention, the optical recording medium is flipped between writing data on the data layer and writing visible information on the label layer. On the basis of this flipping, many embodiments of the invention are provided, as will be discussed hereinafter.

For example, the first wavelength is a wavelength (405 nm) used for Blu-ray Disc (BD) recording projected through a BD optics, and the second wavelength is a wavelength (780 nm) used for CD recording projected through a CD laser optics. A BD is in essence an inverted CD. While the BD has a cover with a thickness of 0.1 mm and a substrate with a thickness of 1.1 mm, the CD can be considered to have a 1.1 mm cover and a 0.1 mm substrate. After writing data through the 0.1 mm layer by using the BD optics, the disc is flipped, and the CD laser can be easily focused on the mirror side of the BD layer by using the CD optics.

According to a further embodiment the first wavelength is a wavelength used for CD recording projected through a CD optics, and the second wavelength is a wavelength used for BD recording projected through a BD optics. Thus, the mentioned CD/BD combination method can be turned around in the sense that the CD is used for data recording and the label is written by the BD wavelength using a BD laser optics. In this case, the label layer is covered by a cover of approximately 0.1 mm thickness, while the data layer is covered by a material having a thickness of 1.1 mm.

According to a further “flipping” embodiment, the first wavelength is a wavelength used for BD recording projected through a BD optics, and the second wavelength (670 nm) is a wavelength used for DVD recording projected through a DVD optics. The data writing is performed on the BD data layer through a cover layer of approximately 0.1 mm thickness. The label layer is about 0.5 mm below the data layer, so that after flipping the disc, the label can be written with the DVD wavelength and optics through a layer of approximately 0.6 mm.

According to a still further embodiment the first wavelength is a wavelength used for DVD recording projected through a DVD optics, and the second wavelength is a wavelength used for BD recording projected through a BD optics. As mentioned before, the BD wavelength can be used for data writing, while the DVD wavelength is used for label writing. On the basis of a different recording medium having a label layer covered by a layer of approximately 0.1 mm, a data layer having a distance of approximately 0.5 mm from the label layer and a cover covering the data layer of approximately 0.6 mm, the label writing can be performed by the BD wavelength and optics, while the data writing is the usual DVD data writing.

Further, it is possible that the first wavelength is a wavelength used for BD recording projected through a BD optics, and the second wavelength is a wavelength used for HD-DVD recording projected through a HD-DVD optics. Such an embodiment is interesting for the situation of optical devices that are able to read and write in the BD and in the HD-DVD formats, while preferably also being able to read and write in the CD and DVD formats. As in the case of label writing with the DVD wavelength and optics, the writing of the label by the HD-DVD wavelength optics is performed through the cover layer thickness of 0.6 mm that is typical for HD-DVD writing/reading.

According to a further embodiment it is possible that the first wavelength is a wavelength used for HD-DVD recording projected through a HD-DVD optics, and the second wavelength is a wavelength used for BD recording projected through a BD optics. Writers that are able to write in the BD and in the HD-DVD formats have the ability to write data through a 0.6 mm cover using the HD-DVD equipment, while the label is written from the other side through a 0.1 mm cover using the BD equipment.

A further method according to the present invention in which the disc is flipped between data writing and label writing is provided when the first wavelength is a wavelength used for DVD recording projected through a DVD optics, and the second wavelength is a wavelength used for DVD recording projected through a DVD laser optics. This is a special case in which for both writing actions the same laser and the same optics can be used. The embodiment is realized by providing an optical recording medium having a substrate thickness that is comparable to the cover thickness. Thus, after writing data to the disc and flipping the disc, the beam can be focused on the label layer through the substrate having an adequate thickness.

According to the present invention it is possible that the first wavelength is a wavelength used for DVD recording projected through a DVD optics, and the second wavelength is a wavelength used for HD-DVD recording projected through a HD-DVD optics. For both DVD and HD-DVD, the cover layer is approximately 0.6 mm. With a label layer directly below the data layer, this label layer will be accessible by the wavelength used for HD-DVD using the HD-DVD laser optics.

The present invention is also employable when the first wavelength is a wavelength used for HD-DVD recording projected through a HD-DVD optics, and the second wavelength is a wavelength used for DVD recording projected through a DVD optics. The DVD-HD/DVD combination has already been discussed as being particularly useful since the cover layers for both HD-DVD and DVD is approximately 0.6 mm. Thus, the HD-DVD wavelength can also be used for data writing, while the DVD wavelength is used for label writing.

Further, it is possible that the first wavelength is a wavelength used for HD-DVD recording projected through a HD-DVD optics, and the second wavelength is a wavelength used for HD-DVD recording projected through a HD-DVD optics. Similar as in the DVD/DVD case, also both writing processes can be performed by the HD-DVD wavelength and optics.

After having discussed various possibilities in which the optical recording medium is flipped between the data and label writing, a further group of embodiments will be mentioned in which the optical recording medium is illuminated from the same side when writing data on the data layer and when writing visible information on the label layer. Such a method can be performed on the basis of an optical recording medium having a hybrid mirror which is substantially transparent for a first wavelength but substantially reflective for a second wavelength.

For example, the first wavelength is a wavelength used for BD recording projected through a BD optics, and the second wavelength is a wavelength used for CD recording projected through a CD optics. On the basis of an optical medium having a data layer underneath a 0.1 mm cover followed by a hybrid mirror that is reflective for the BD wavelength, data can be written by the BD laser and optics. In a distance of approximately 1.0 mm underneath the hybrid mirror, a label layer is provided on which the CD wavelength beam can be focused using the CD laser and the CD optics, since the hybrid mirror is transmissive for the CD wavelength.

The method without flipping is also applicable when the first wavelength is a wavelength used for DVD recording projected through a DVD optics, and the second wavelength is a wavelength used for BD recording projected through a BD optics. In this case, a medium is provided in which on top of the label layer a cover of approximately 0.1 mm is provided. Underneath the label layer a hybrid mirror is positioned that is reflective for the BD wavelength and transmissive for the DVD wavelength. In a distance of approximately 0.5 mm underneath the hybrid mirror a data layer is provided in which data can be written by using the DVD wavelength and optics.

As another example, the first wavelength is a wavelength used for HD-DVD recording projected through a HD-DVD optics, and the second wavelength is a wavelength used for CD recording projected through a CD optics. On the basis of an optical medium having a data layer underneath a 0.6 mm cover followed by a hybrid mirror that is reflective for the HD-DVD wavelength, data can be written by the HD-DVD laser and optics. In a distance of approximately 0.5 mm underneath the hybrid mirror, a label layer is provided on which the CD wavelength beam can be focused using the CD laser and the CD optics, since the hybrid mirror is transmissive for the CD wavelength.

The method without flipping is also applicable when the first wavelength is a wavelength used for DVD recording projected through a DVD optics, and the second wavelength is a wavelength used for HD-DVD recording projected through a HD-DVD optics. In this case, a medium is provided in which on top of the label layer a cover of approximately 0.6 mm is provided. Underneath the label layer a hybrid mirror is positioned that is reflective for the HD-DVD wavelength and transmissive for the DVD wavelength. In a small distance underneath the hybrid mirror a data layer is provided in which data can be written by using the DVD wavelength and optics.

According to a preferred embodiment, the method of the present invention comprises the further steps of:

(a) providing an optical pickup unit (OPU),

(b) using a wavelength used for BD recording as the first wavelength and a BD optics,

(c) using a wavelength used for CD recording as the second wavelength and a CD laser optics,

(d) positioning the OPU relative to the optical recording medium by using the first wavelength and a BD laser optics for determining the position of the OPU relative to the optical recording medium,

(e) turning on a laser beam having the second wavelength using the CD laser optics,

(f) writing a visible information item on the label layer by the laser beam having the second wavelength using the CD laser optics, and

(g) repeating steps (d) to (f) until a desired label has been written.

This method is employable with the present invention in case that the optical recording medium is illuminated from the same side when writing data and when writing visible information. Thus, the disc is brought in focus using the BD branch. The positioning during CD recording is performed on the basis of the BD laser optics and information on the BD data layer, particularly addresses in pre-groove (ADIP). It is also possible to count the number of tracks on the BD data layer while the OPU is moving on the basis of the TCS (track cross signal) or by using the DPD (differential phase detection) signal and counting the phase jumps.

Particularly, positioning of the OPU in step (d) comprises shifting the OPU.

Additionally it is possible that positioning of the OPU in step (d) comprises tilting the OPU.

Furthermore, after step (e), if the CD laser beam is not sufficiently focused, the OPU is re-positioned.

According to a preferred embodiment, the positioning of the OPU in step (d) is performed such that in step (f) the CD laser spot is positioned adjacent an item of information written during a previous execution of step (f). This is possible when the accuracy of OPU positioning is better than the spot size of the CD laser.

According to a preferred embodiment of the present invention, the writing of visible information on the label layer is performed by writing spiral tracks, the track pitch defining the optical contrast of the visible information. The label is an image formed by several pixels. Each pixel consists of several tracks written by the laser spot. If the track pitch is small, the contrast of the label is high. A greater track pitch will lead to less contrast.

The present invention is further related to an optical recording medium for being used in a method according to the present invention.

Particularly, the at least one data layer and the at least one label layer are covered by layers that are transparent for the applied wavelengths, the layers having a thickness that allows focusing of the laser beams onto the data layer and onto the label layer to a spot size that is employable for writing data on a data layer for storing data readable by use of an optical readout device.

For example, the optical recording medium comprises the following sequence of layers:

a polycarbonate layer,

a label layer or label layer stack, a data layer or data layer stack, and a polycarbonate layer.

In a further embodiment the optical recording medium comprises the following sequence of layers:

a polycarbonate layer,

a label layer or label layer stack,

a thermal isolation layer,

a data layer or data layer stack, and

a polycarbonate layer.

The two aforementioned recording media can be used when the label layer and the data layer may be positioned approximately in the same depth of the medium, for example in the case of BD data recording and CD label writing with “flipping”. The thermal isolation layer is useful in order to prevent an excessive heat transfer from the data layer to the label layer or vice versa.

According to a further embodiment, the optical recording medium comprises the following sequence of layers:

a polycarbonate layer,

a label layer or label layer stack,

a polycarbonate layer,

a data layer or data layer stack, and

a polycarbonate layer.

This sequence is useful when a distance between the label layer and the data layer is required so as to enable, for example, BD label writing and DVD data recording with “flipping”.

According to a further embodiment, the optical recording medium of the present invention comprises the following sequence of layers:

a polycarbonate layer,

a label layer or label layer stack,

a polycarbonate layer,

a mirror layer being selectively transparent for different wavelengths,

a data layer or data layer stack, and

a polycarbonate layer.

Such a sequence of layers is useful for writing BD data and CD label writing from the same side of the optical recording medium.

In order to write for example DVD data and BD labels from the same side it is useful to have an optical recording medium comprising the following sequence of layers:

a polycarbonate layer,

a data layer or data layer stack,

a polycarbonate layer,

a mirror layer being selectively transparent for different wavelengths,

a label layer or label layer stack, and

a polycarbonate layer.

According to a still further embodiment of the present invention the optical recording medium comprises the following sequence of layers:

a polycarbonate layer,

a label layer or label layer stack,

a bonding layer,

a data layer or data layer stack, and

a polycarbonate layer having a groove structure.

The polycarbonate layer adjacent the data layer contains the normal groove structure for data recording. In case of DVD this layer has a thickness of approximately 0.6 mm. Further, a 0.6 mm grooved dummy disc is provided as the polycarbonate layer adjacent the label layer. The bonding layer between the label layer and the data layer provides a thermal isolation. In order to simplify this type of optical recording medium, the groove structure of the polycarbonate layer adjacent the label layer can be left out.

The present invention further relates to a method of manufacturing an optical recording medium according to the present invention, the method comprising the steps of:

providing a first stack of a polycarbonate layer having a label layer or label layer stack on top of the polycarbonate layer,

providing a second stack of a grooved polycarbonate layer having a data layer or data layer stack on top of the grooved polycarbonate layer, and

bonding the first stack and the second stack together by providing a bonding layer between the label layer and data layer, the label layer and data layer stack, the label layer stack and data layer or the label layer stack and data layer stack. In this way, a simple manufacturing process is provided that is based on a normal grooved substrate with recording layer and a dummy substrate supporting a label layer. After having prepared these two stacks, they can be glued together, the glue being thick enough (e.g. 50 μm) to prevent heat flowing from the data layer to the label layer and vice versa.

These and other aspects of the invention will be apparent from and elucidated with reference to the embodiments described hereinafter.

### BRIEF DESCRIPTION OF THE DRAWINGS

FIG. 1 illustrates a method and an optical recording medium according to the present invention.

FIG. 2 illustrates a further method and a further optical recording medium according to the present invention.

FIG. 3 illustrates an optical recording medium according to the present invention;

FIG. 4 illustrates a further method and a further optical recording medium according to the present invention.

FIG. 5 illustrates a further optical recording medium according to the present invention.

FIGS. 6a to 6c illustrate surface areas of an optical recording medium according to the present invention.

FIG. 7 illustrates two further methods and two further optical recording media according to the present invention.

FIG. 8 illustrates two further optical recording media according to the present invention.

FIG. 9 illustrates two further methods and two further optical recording media according to the present invention.

FIG. 10 illustrates two further optical recording media according to the present invention.

FIG. 11 illustrates a further optical recording medium according to the present invention.

FIG. 12 illustrates a further optical recording medium according to the present invention.

FIG. 13 illustrates a further method and a further optical recording medium according to the present invention.

FIG. 14 illustrates a further method and a further optical recording medium according to the present invention.

FIG. 15 illustrates a further method and an optical recording medium according to the present invention.

FIG. 16 illustrates a further method and a further optical recording medium according to the present invention.

FIG. 17 illustrates a further method and a further optical recording medium according to the present invention.

FIG. 18 illustrates a further method and a further optical recording medium according to the present invention.

### DESCRIPTION OF PREFERRED EMBODIMENTS

In the following detailed description of preferred embodiments, identical reference numerals refer to identical or comparable features. However, it has to be noticed that also different reference numerals may refer to identical or comparable features.

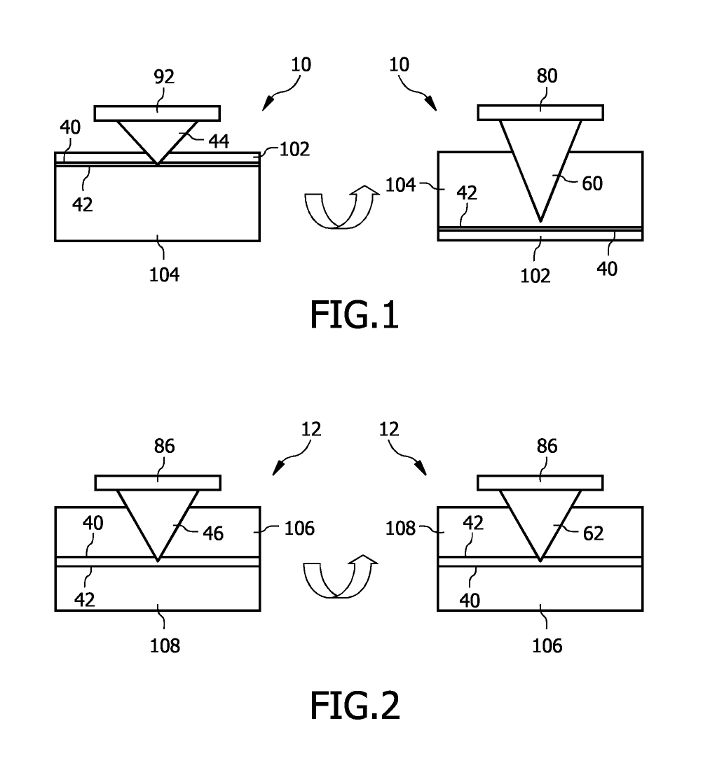

FIG. 1 illustrates a method and an optical recording medium 10 according to the present invention. The optical recording medium 10, a part of which is shown in FIG. 1, has the following sequence of layers: a substrate layer 104, e.g. formed from polycarbonate, a label layer or label layer stack 42 that will be described in further detail below, a data layer or data layer stack 40 that will also be described in further detail below, and a cover layer 102, also preferably formed from polycarbonate. The thickness of the cover layer 102 is chosen such that the data layer 40 is accessible by a focused BD laser beam 44 by use of a BD optics 92. The thickness of the substrate layer 104 is chosen such that the label layer 42 is accessible by a focused CD laser beam 60 by use of a CD optics 80. Thus, in an optical device having a BD optics 92 and a CD optics 18 on the same side of the optical recording medium 10, BD data can be written to the data layer 40. After flipping the disc, a visible layer can be written to the label layer 42 by use of a CD optics. This embodiment and further embodiments described herein are not limited to the sequence of first writing the data and then writing the label. Rather, also the label writing can be performed before the data writing. Further, all of the various methods containing a flipping step can be modified to methods without flipping steps by using an optical device that has the particular lasers and optics arranged on different sides of the recording medium.

FIG. 2 illustrates a further method and a further optical recording medium 12 according to the present invention. The same principle that has been described with reference to FIG. 1 also applies to DVD data writing and DVD label writing. By use of a DVD optics 86 a DVD wavelength laser beam 46 is focused onto the data layer of an optical recording medium 12. The thickness of the cover layer 106 on top of the data layer 40 is approximately 0.6 mm. After flipping of the optical recording medium 12, the DVD optics 86 can be used to project a focused laser beam 62 onto the label layer 52 through the substrate 108. For this purpose also the substrate 108 has a thickness of approximately 0.6 mm.

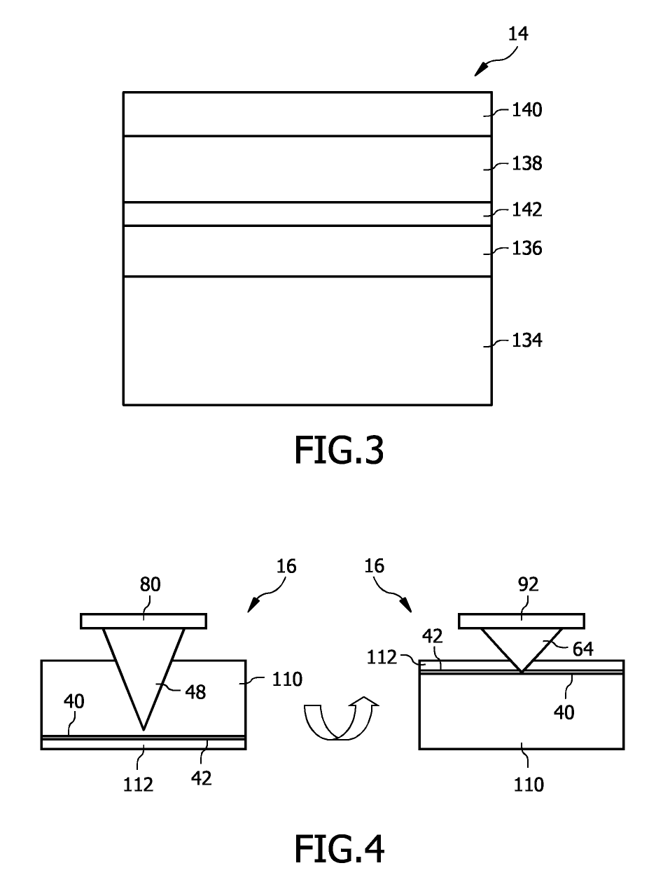

FIG. 3 illustrates an optical recording medium 14 according to the present invention. A particular stack that can be used for the method described in connection with FIG. 1 is shown. The substrate layer 134 of the optical recording medium 14 has a thickness of 1.1 mm. On top of the substrate layer 134 a label layer 136 is provided. The label layer 136 is followed by a thermal isolation layer 142. On top of the thermal isolation layer 142 a data layer stack 138 is arranged. The data layer stack 138 is covered by a cover layer of a thickness of approximately 0.1 mm.

FIG. 4 illustrates a further method and a further optical recording medium 16 according to the present invention. The optical recording medium 16 used here is different from the optical recording medium 10 explained in connection with FIG. 1 in that the roles of the data layer 40 and the label layer 42 are exchanged. The data layer 40 is covered by a thick layer 110 of approximately 1.1 mm in order to allow data writing by a CD optics 80 and a focused CD laser beam 48. The label layer 42 is covered by a thin cover 112 of 0.1 mm so that by BD optics 42 a BD laser beam 64 can be focused on the label layer 42 for label writing.

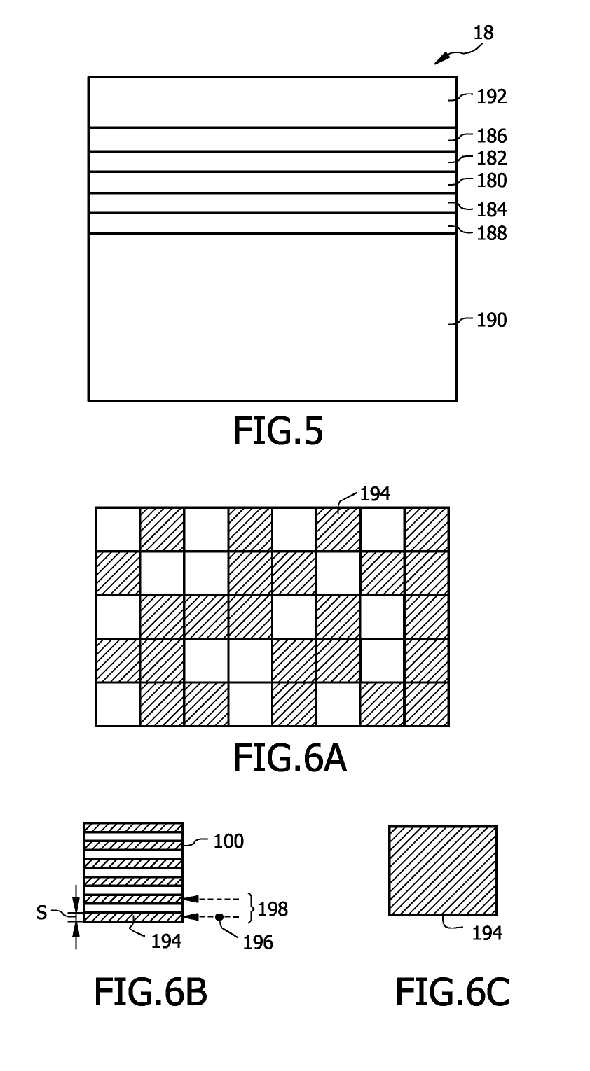

FIG. 5 illustrates a further optical recording medium according to the present invention. The optical recording medium 18 comprises of a Cu—Si stack 180, 182 having a Cu layer 180 and an Si layer 182. Both of those layers have a thickness between 1 and 10 nm. On both sides of the Cu—Si stack 180, 182, ZS82 (a dielectric layer of 80 at % ZnS/20 at % SiO₂) layers 184, 186 are arranged having a thickness of between 10 and 70 nm. Underneath of the ZS82 layer 184 an Ag layer 188 having a thickness of between 10 and 100 nm is provided. The Ag layer 188 is supported by a polycarbonate substrate 190 having a thickness of 1.1 mm. The upper ZS82 layer 186 is covered by a cover layer 192 of 100 μm. Normal stacks that are optimized for data writing are particularly optimized to get the lowest jitter. Reflection, contrast and modulation can only be modified a little. For the label writing according to the present invention the data writing does not have to be optimized, rather the reflection and contrast properties can be optimized. Furthermore, as compared with data writing, label writing provides more room for varying the power and the writing speed.

In the case of a combination of CD and BD, the CD stack can be made of the same materials as the BD stack. Also a combination of different materials is possible. For reasons of costs, using the same materials for the CD stack and the BD stack is preferable. The complete stack comprising label and data layers can then be applied in one run.

The optical recording medium shown in FIG. 5 comprising the Cu/Si stack 180, 182 shows particularly good results for BD write once recording. Other candidates are Sn, In, Bi, Al, Ti. For environmental reasons, the Cu/Si system is preferable. Also phase-change material can be used, enabling to use rewritable labels on rewritable discs. Furthermore, rewritable label layers are usable in combination with write once data layers and vice versa.

The optical recording medium 18 shown in FIG. 5 can easily be tuned for an optimum of its reflection properties. For example, for a stack with 50 nm Ag/x nm ZS82/6 nm Cu/6 nm Si/40 nm ZS82, the reflectivity at 405 nm can be adjusted between 7 and 70% by varying x between 20 and 60 nm. The fine-tuning is possible by adjusting the thickness of the upper ZS82 layer 186. Similar variations are achievable at different wavelengths.

It is also possible to use dye label layers. In this connection it has to be considered that grooves in the substrate are filled by the dye. Thus, the data layers will be based on a different groove form. Therefore, the groove forms of the substrate and the filling procedure have to be adjusted so as to provide the desired groove form for the data layer.

In case of DVD data writing and DVD label writing as explained in connection with FIG. 2, both of the stacks can be made of the same or different materials, while the use of the same materials is advantageous.

The labeling by the DVD optics or the CD optics differs in the way tracking is used. In case of a DVD label writing, tracking can be performed in the usual way. In case of a BD data disc with CD labeling, the CD optics will not be able to follow the tracks. The movement of the spot has to be controlled by using a combination of the sledge motor and the radial movement of the actuator.

FIGS. 6a to 6c illustrate surface areas of an optical recording medium according to the present invention. In FIG. 6a a pattern of a plurality of pixels 194 is shown. FIG. 6c shows one such single pixel 194. In FIG. 6b it is illustrated how this single pixel 194 is structured and written by the labeling step according to the present invention. The pixel 194 comprises of a plurality of tracks 100 that are written by the focused laser beam on the basis of a spot 196 having small size. For example, the spot size can be chosen as small as it is also chosen for data writing. The spot size determines the width S of the tracks 100. Further, the track pitch 198 can be adjusted in order to obtain a desired contrast. The larger the track pitch 198, the lower the contrast.

The movement of the spot 196 is constrained by two conditions. First, a pixel has to be written with a size dependent on the dpi (Dots Per Inch) value. The pixel size in radial direction will be determined by the TPI (Tacks Per Inch) value chosen. The distance r between the tracks has to be greater or equal to the width s of the written region on the disc. The reflection of a pixel will be less effective for a larger r. The positioning of the laser spot in adjacent tracks can be done by either a sledge motor with high resolution, by radial movement of the actuator or by tilting the head of the optical pick up unit.

For example, on the basis of the present invention, a dark concentric spiral having a width of ±0.6 μm can be written with a writing speed of v=19.2 m/s which corresponds to 16× writing. The write power can be chosen as 20 mW or less. The track pitch is chosen to be 2 μm for high resolution or 4 μm for low resolution. The total time needed to write this concentric spiral on the whole disc is less than 4 minutes for high resolution and less than 2 minutes for low resolution.

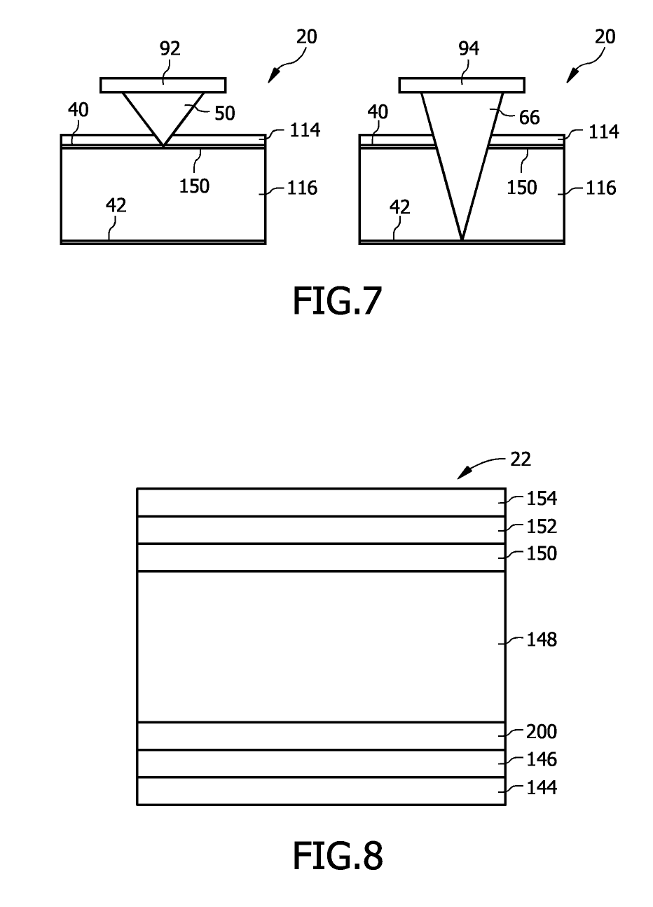

FIG. 7 illustrates a further method and a further optical recording medium 20 according to the present invention. The optical recording medium 20 used here comprises of a thin cover layer (not shown), a label layer 42, a substrate layer 116, a hybrid mirror layer 150, a data layer 40 and a cover layer 114. The hybrid mirror layer 150 is for example realized as a stack of ZS82/SiO₂/ZS82. The hybrid mirror layer 50 is substantially reflective for the BD laser beam 50 that is focused by the BD laser optics 92 onto the data layer 40. However, the hybrid mirror layer 150 is substantially transmissive for the CD laser beam 66 that is focused by the CD optics 94 onto the label layer 42. On this basis, the data writing and the label writing can be performed from the same side of the optical recording medium 20. The thicknesses of the layers 116 and 114 are chosen such that the requirements for the corresponding optics, BD and CD, are fulfilled.

FIG. 8 illustrates a further optical recording medium 22 according to the present invention. According to this particular embodiment of an optical recording medium 22 for employing the method described in connection with FIG. 7, the following sequence of layers is chosen: a protection layer 144 having a thickness smaller or equal 100 μm, a label layer 146, an optional hybrid mirror 200, a substrate 148 having a thickness of approximately 1.0 mm, a hybrid mirror layer 150, a data layer 152, and a cover layer 154 having a thickness of approximately 100 μm. The use of the optional hybrid mirror layer 200 adds to the reflectivity when the whole spectrum is considered. The data layer 152 can be a write once or a rewriteable data layer stack.

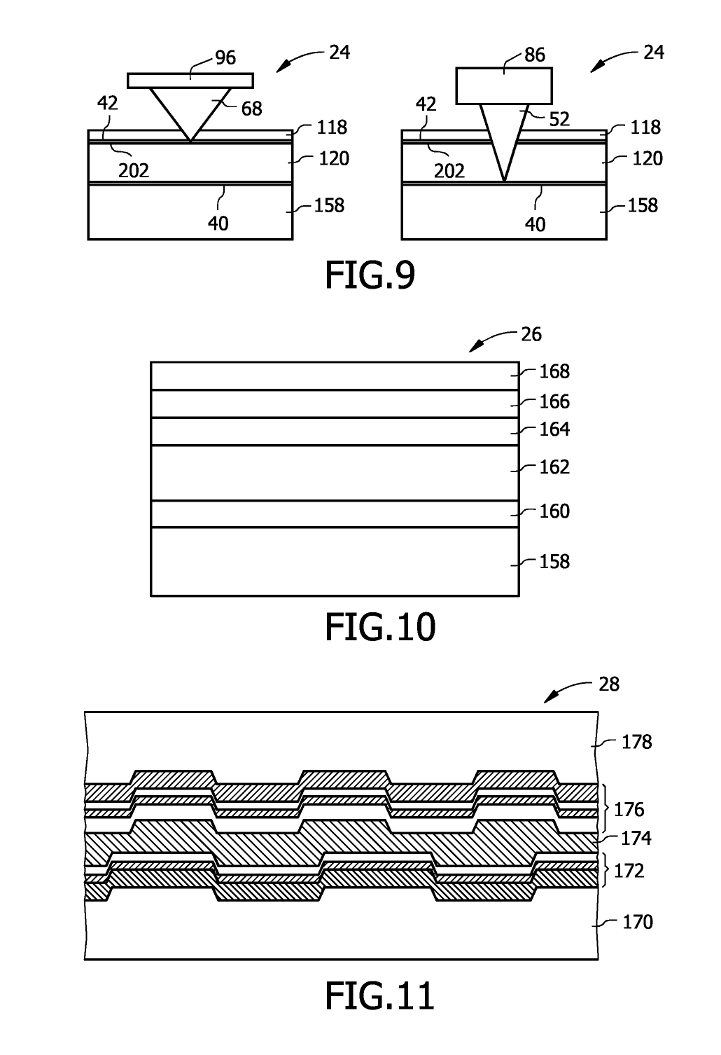

FIG. 9 illustrates a further method and a further optical recording medium 24 according to the present invention. The optical recording medium 24 shown here can be used for label writing by the BD wavelength beam 68 focused by a BD optics 96 onto a label layer stack 42. Data writing is performed by focusing a DVD laser beam 52 by the use of a DVD laser optics 86 onto the data layer 40. Again, a hybrid mirror layer 202 is provided that reflects the BD wavelength and transmits the DVD wavelength. Below the data layer 40, as seen from the laser optics 86, 96, a substrate layer 158 is provided.

FIG. 10 illustrates a further optical recording medium 26 according to the present invention. An optical recording medium 26 that can be used in connection with a method as described in connection with FIG. 9 is formed by the following sequence of layers: a substrate layer 158 having a thickness of approximately 0.6 mm, a data layer 160, distance layer 162 having a thickness of approximately 0.5 mm, a hybrid mirror layer 164, a label layer 166, and a cover layer having a thickness of approximately 100 μm.

The optical recording media described in connection with FIGS. 7 to 10 are fundamentally different from a hybrid BD-CD disc or BD-DVD disc. The label layer does not contain data to be read by the drive. The patterns on the label layer are much larger than the typical marks of a CD, DVD or BD, and they extend over several tracks, if such tracks are present. The information on the label layer is directly coupled to the data layer, in that sense that it generally contains information about the contents of the data layer. Further, the label layer does not necessarily contain grooves. It can be advantageous not to contain any grooves, since this will simplify the fabrication of the disc. The label layer could be made of a strip having the correct thickness which is simply glued on top of the data disc. This also facilitates the use of dye for the label stack, in view of the problems with dye filling the grooves of a grooved substrate as already discussed above.

The FIGS. 7 to 10 can also be taken as the description of a further embodiment of the present invention, namely the combination of HD-DVD data writing and CD label writing as well as for DVD data writing and HD-DVD label writing. Thus, FIG. 7 can be taken as an illustration, wherein the optical recording medium 20 used here comprises of a 0.6 mm cover layer (not shown), a label layer 42, a substrate layer 116, a hybrid mirror layer 150, a data layer 40 and a cover layer 114. The hybrid mirror layer 150 is for example realized as a stack of ZS82/SiO2/ZS82. The hybrid mirror layer 50 is substantially reflective for the HD-DVD laser beam 50 that is focused by the HD-DVD laser optics 92 onto the data layer 40. However, the hybrid mirror layer 150 is substantially transmissive for the CD laser beam 66 that is focused by the CD optics 94 onto the label layer 42. On this basis, the data writing and the label writing can be performed from the same side of the optical recording medium 20. The thicknesses of the layers 116 and 114 are chosen such that the requirements for the corresponding optics, HD-DVD and CD, are fulfilled.

FIG. 8 can be taken as an illustration of a further optical recording medium 22 according to the present invention. According to this particular embodiment of an optical recording medium 22 for employing the method described in connection with FIG. 7 in its second interpretation, the following sequence of layers is chosen: a protection layer 144 having a thickness smaller or equal 600 μm, a label layer 146, an optional hybrid mirror 200, a substrate 148 having a thickness of approximately 0.5 mm, a hybrid mirror layer 150, a data layer 152, and a cover layer 154 having a thickness of approximately 100 μm. The use of the optional hybrid mirror layer 200 adds to the reflectivity when the whole spectrum is considered. The data layer 152 can be a write once or a rewriteable data layer stack.

FIG. 9 can be taken as an illustration of a further method and a further optical recording medium 24 according to the present invention. The optical recording medium 24 shown here can be used for label writing by the HD-DVD wavelength beam 68 focused by a HD-DVD optics 96 onto a label layer stack 42. Data writing is performed by focusing a DVD laser beam 52 by the use of a DVD laser optics 86 onto the data layer 40. Again, a hybrid mirror layer 202 is provided that reflects the HD-DVD wavelength and transmits the DVD wavelength. Below the data layer 40, as seen from the laser optics 86, 96, a substrate layer 158 is provided.

FIG. 10 can be taken as an illustration of a further optical recording medium 26 according to the present invention. An optical recording medium 26 that can be used in connection with a method as described in connection with FIG. 9 in its second interpretation is formed by the following sequence of layers: a substrate layer 158 having a thickness of approximately 0.6 mm, a data layer 160, a thin distance layer 162, a hybrid mirror layer 164, a label layer 166, and a cover layer having a thickness of approximately 600 μm.

The optical recording media described in connection with FIGS. 7 to 10 according to their second interpretation are fundamentally different from a hybrid HD-DVD-CD disc or HD-DVD-DVD disc. The label layer does not contain data to be read by the drive. The patterns on the label layer are much larger than the typical marks of a CD, DVD or HD-DVD, and they extend over several tracks, if such tracks are present. The information on the label layer is directly coupled to the data layer, in that sense that it generally contains information about the contents of the data layer. Further, the label layer does not necessarily contain grooves. It can be advantageous not to contain any grooves, since this will simplify the fabrication of the disc. The label layer could be made of a strip having the correct thickness which is simply glued on top of the data disc. This also facilitates the use of dye for the label stack, in view of the problems with dye filling the grooves of a grooved substrate as already discussed above.

FIG. 11 illustrates a further optical recording medium 28 according to the present invention. The optical recording medium 28 illustrated here has particular advantages with respect to the thermal properties during data writing and/or label writing. The optical recording medium comprises of the following sequence of layers: a substrate layer 170 (dummy layer) having a (optional) groove structure. The dummy layer 170 has a thickness of about 0.6 mm. The dummy layer 170 is followed by a label layer stack 172. On top of the label layer stack 172 a bonding layer 174 is provided. The bonding layer 174 is followed by a data layer stack 176. On top of the data layer stack 176 a grooved substrate 178 is arranged. The thickness of the substrate 178 is also about 0.6 mm. Thus, a DVD with labeling capabilities is provided, composed of two parts. As the first part, the 0.6 mm active substrate 178 contains the normal groove structure for data recording. On this substrate the rewritable data layer stack 176 containing a phase change layer or a recordable data layer stack 176 consisting of an organic dye layer and metal mirror are applied. The second part can be formed of a full stack containing the substrate layer 170 and the label layer stack 172. In order to combine these two parts to the optical recording medium 28 as shown in FIG. 11, these parts are glued together.

The optical recording medium 28 is particularly advantageous.

The bonding layer 174 is thick enough (approximately 50 μm) to prevent heat flowing from the data layer 176 to the label layer 172 and vice versa. Not all elements of the label stack 172 are necessary. For example, the label stack 172 might not need a heat sink, thus the mirror layer can be left out. Since the data layer stack 176 has a mirror, the back of this mirror will act as a mirror for the data layer stack 176.

It is possible to use dye labels.

The dummy layer 170 can contain a groove structure with the necessary information in the ADIP that is needed for writing the label side.

A DVD disc can be made, fully compliant to the standard.

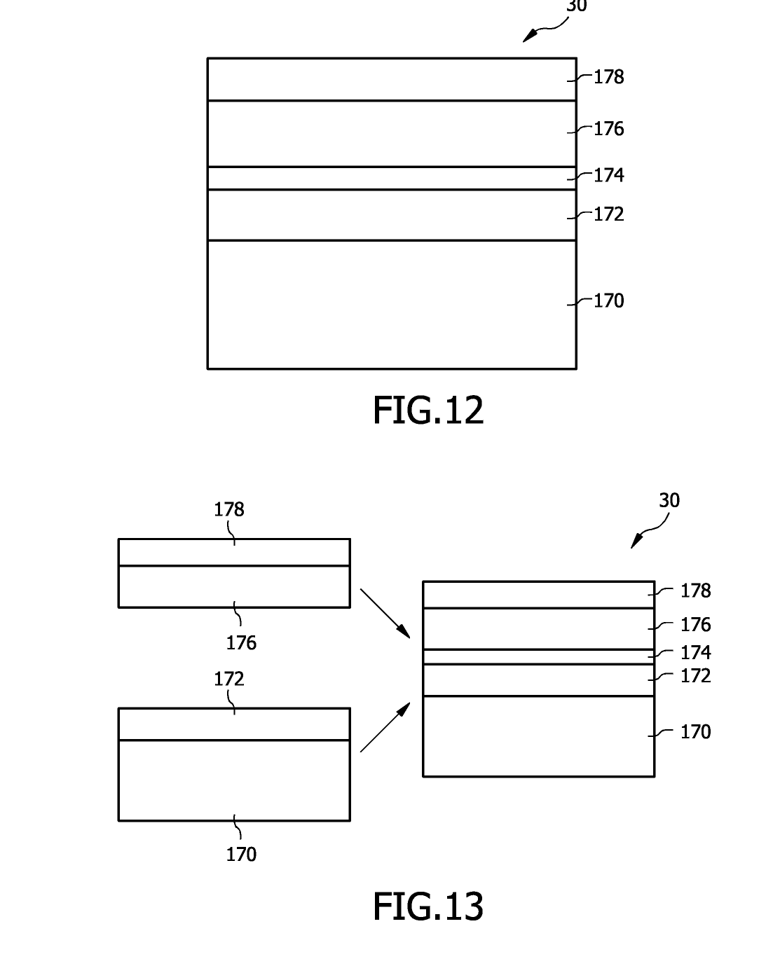

FIG. 12 illustrates a further optical recording medium 30 according to the present invention. A simplified illustration of the optical recording medium 28 of FIG. 11 is shown as the optical recording medium 30. The upper polycarbonate layer 178 of 0.6 mm thickness is grooved. The lower polycarbonate layer 170 of identical thickness can be grooved but needs not to be grooved.

FIG. 13 illustrates a further method and a further optical recording medium according to the present invention. It is illustrated how the optical recording medium 30 can be manufactured, namely in combining an active substrate 178 having a data layer stack 176 and a dummy substrate 170 having a label layer stack 172 by gluing the units together, thereby providing a thermally insulating bonding layer 174.

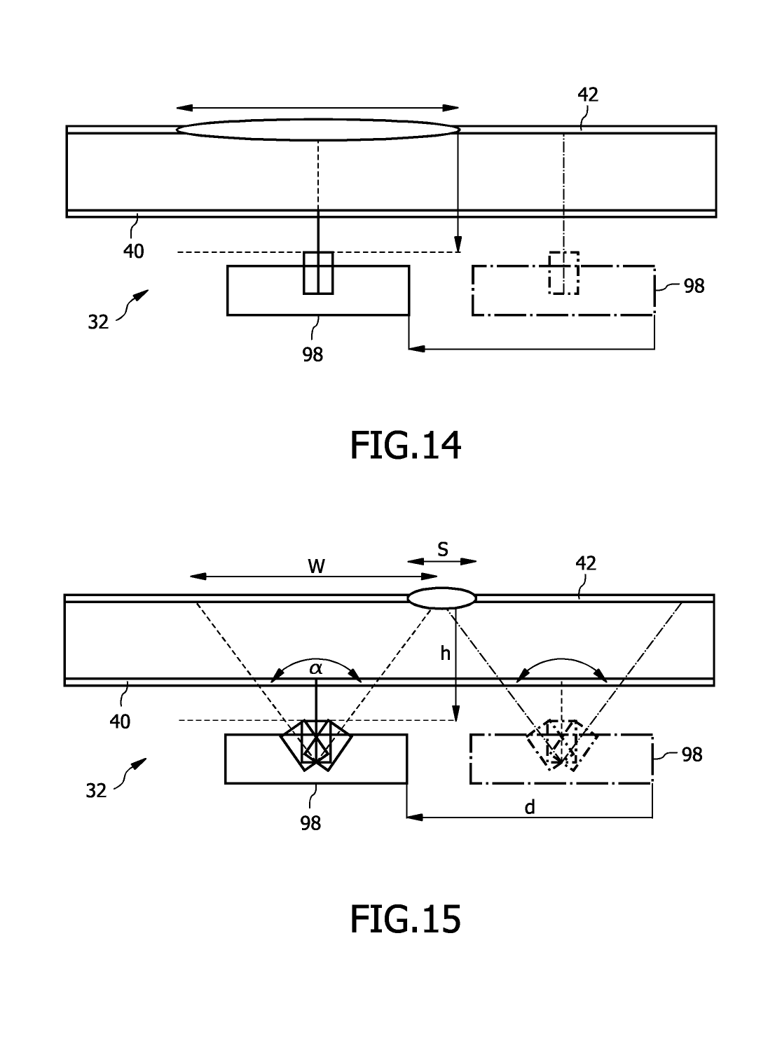

FIGS. 14 and 15 illustrate further methods and a further optical recording medium 32 according to the present invention. The methods illustrated in connection with FIGS. 14 and 15 are relevant for the embodiments in which the label information and data are written from the same side of the optical recording medium. The methods are described in connection with BD data writing and CD label writing, as illustrated in connection with FIGS. 7 and 8. However, the principles explained in connection with FIGS. 14 and 15 can be easily transferred to the BD label writing and DVD data writing case as explained with reference to FIGS. 9 and 10.

The optical recording medium 32 contains a label layer 42 and a data layer 40. Both of these layers can be covered by cover layers (not shown). In addition to the optical recording medium 32 the optical pick up unit (OPU) 98 is illustrated in different positions.

In order to position the OPU 98 relative to the optical recording medium 32 for label writing, the following steps are performed. The optical recording medium is brought into focus by using the BD branch. First, the disc eccentricity is measured by letting the disc spin a few times. The results can be used in a Feed Forward sense. Then, the CD branch is turned on. Now, two different observations can be made: (i) the CD laser is sufficient in focus; (ii) it is necessary to adjust the height of the OPU 98 to get the right focus for the CD laser. In case (i) the implementation is straightforward. The BD laser is used to locate the track after the OPU sledge has moved into another position. The track is read out with the objective lens located in the central position of the OPU 98. Now it can be calculated how far the head has to tilt in order to cover the whole area between the previous written label mark and the position for the next spot. In case (ii) the OPU has to be moved in order to enable the BD and CD lasers to be in focus.

In dependence on the accuracy (d) of the OPU movement two different solutions are proposed.

For an accuracy d better than the CD laser spot size s (d<s) (see FIG. 14) the OPU can be moved so that the spot of the CD laser can be placed adjacent to the position of the former step. After the label has been written over one revolution, the CD laser is turned off and the BD laser is turned on and brought into focus. The OPU is now moved over enough ADIP addresses, in order to avoid overlap of the CD spots. When the right address is found, the CD laser is focused again on the label and the label is written again for a full rotation.

For a spot size s smaller than the accuracy d (d>s) (see FIG. 15) a different solution is advantageous. After the OPU 98 has moved over the distance d, the BD laser is turned on, and the track location of the track seen by the objective lens in its straight up position is measured. From the track ADIP, the exact distance d the OPU has moved can be calculated. When the spot size s and the distance h between the lens and the label layer is known, the angle α over which the OPU has to rotate in order to write the label can be calculated.

Instead of reading the ADIP addresses, the drive can also count the number of tracks while the OPU is moving. This can be done by the Track Cross Signal (TCS, looking at the open loop PushPull signal) or using the differential phase detection (DPD) signal and counting the phase jumps. Furthermore, if the OPU position is calibrated very well, this can also be used.

Preferably, the following parameters can be measured at startup of the label writing:

The spot size s.

The relation between α and writing area w.

The minimum distance d over which the OPU can be moved accurately.

The distance h between the label layer and the objective lens.

These data can be measured by using special patterns added to the inner side of the disc.

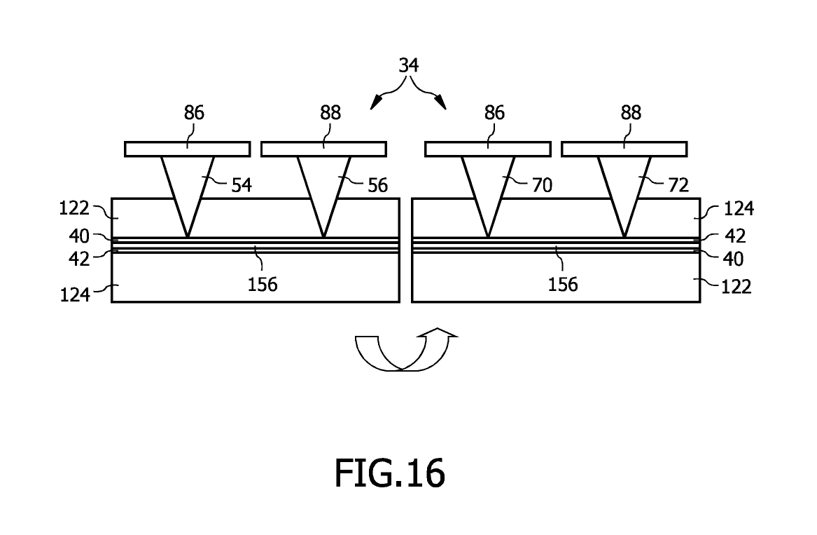

FIG. 16 illustrates a further method and a further optical recording medium 34 according to the present invention. In a HD-DVD writer, a HD-DVD, DVD or a hybrid HD-DVD/DVD disc can be read and written. For both, HD-DVD and DVD, the cover layer is 0.6 mm. On this basis the optical recording medium 34 is designed, having two cover layers 122, 124, a data layer 140 underneath the cover layer 122 and a label layer 142 underneath the other cover layer 124. A thin polycarbonate layer 156 is provided between the data layer 40 and the label layer 42. Thus, both, the data layer 40 and the label layer 42 are accessible by the red wavelength (660 nm) laser beam 54 focused by the DVD optics 86 and the blue wavelength (405 nm) laser beam 56 focused by the HD-DVD optics 88, depending on the orientation of the disc 34. Thus, the “flipping” method can be applied to write data with the DVD optics, the HD-DVD optics or a combination thereof. The same applies for writing the label.

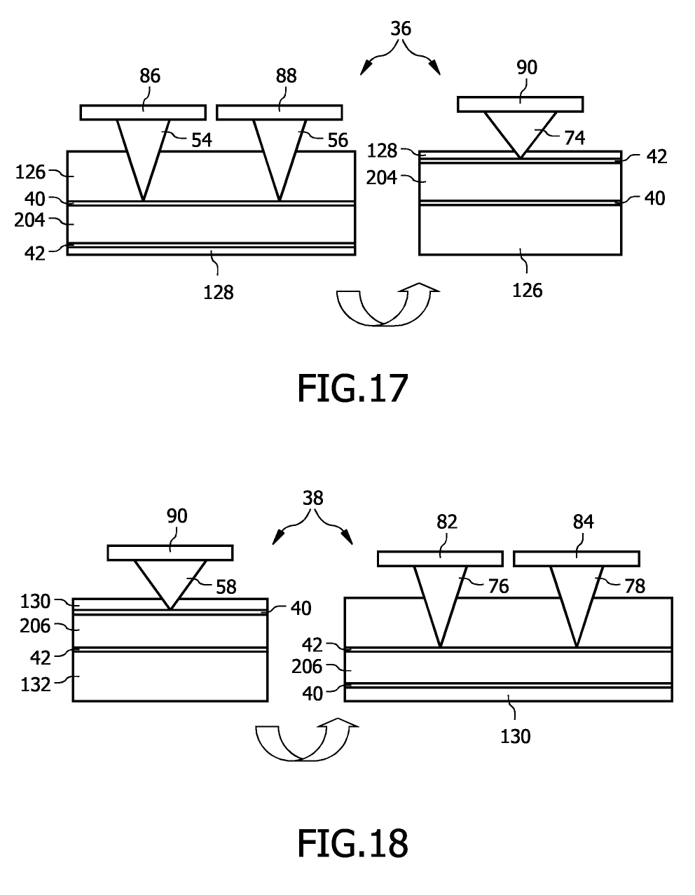

FIG. 17 illustrates a further method and a further optical recording medium 36 according to the present invention. This method is relevant for optical devices in which the DVD and/or the HD-DVD standard are combined with the BD standard. The optical recording medium 36 comprises layers of the following sequence: a 0.1 mm cover layer 128, a label layer 42, a distance layer 204 having a thickness of approximately 0.5 mm, a data layer 40, and a cover layer 126 having a thickness of approximately 0.6 mm. Thus, through the cover layer 126, data writing is possible on the basis of the DVD optics 86, the HD-DVD optics 88 and the corresponding focused laser beams 54, 56 or combinations thereof. After flipping the disc, laser writing can be performed through the 0.1 mm cover layer 128 by the BD optics 90 and by the BD laser beam 74.

FIG. 18 illustrates a further method and a further optical recording medium according to the present invention. It is also possible to write the data by means of the BD optics 90 and the BD laser beam 58, while writing the label by the DVD optics 82 and the DVD laser beam 76 and/or the HD-DVD optics 84 and the HD-DVD laser beam 78. For this purpose, an optical recording medium 38 is provided comprising a 0.6 mm cover layer 132, a label layer 42, a distance layer 206 having a thickness of approximately 0.5 mm, a data layer 40 and a 0.1 mm cover layer 130.

In the description of the present invention the terms layer and layer stack have been used. Generally, most of the mentioned layers can be substituted by layer stacks and, frequently, a layer stack can be substituted by a single layer.

For both, the data and the label layers, the R (write once) and the RW (rewriteable) options are applicable in any combination.

In the description of the invention the term substrate layer, cover layer, etc has been used. These terms are exchangeable in most cases. The substrate layers, the cover layers, and the intermediate distance layers are preferably made of polycarbonate. However, these layers can also be made from any other suitable material which is compliant with the optics.

The mentioned values, e.g. thicknesses, wavelengths, speeds, widths, etc. have to be taken as approximate values.

The term “visible” as used herein means that the label is visible to the naked eye, while the data written on the data layer are not visible to the naked eye.

Many combinations of data and label writing have been explained. The limited number of described combinations does not mean that the present invention is limited to these combinations. Rather, additional combinations can be employed, particularly on view of future standards.

Equivalents and modifications not described above may also be employed without departing from the scope of the invention, which is defined in the accompanying claims.

1-34. (canceled)

35. A method of writing information on an optical recording medium (10 to 38), the optical recording medium having at least one data layer (40) for storing data readable by use of an optical readout device and at least one label layer (42) for storing visible information, the method comprising the steps of:
focusing a first wavelength laser beam (44 to 58) onto the at least one data layer for writing data on the data layer, and
focusing a second wavelength laser beam (60 to 78) onto the at least one label layer for writing visible information on the label layer, thereby a laser spot size being usable that is also employable when using the second wavelength laser beam for writing data on a data layer for storing data readable by use of an optical readout device,
wherein the first wavelength is different from the second wavelength.

36. The method of writing information on an optical recording medium according to claim 35, wherein the optical recording medium is flipped between writing data on the data layer and writing visible information on the label layer.

37. The method of writing information on an optical recording medium (10) according to claim 36, wherein the first wavelength is a wavelength used for Blu-ray Disc (BD) recording projected through a BD optics (92), and the second wavelength is a wavelength used for CD recording projected through a CD optics (80).

38. The method of writing information on an optical recording medium (16) according to claim 36, wherein the first wavelength is a wavelength used for CD recording projected through a CD optics (80), and the second wavelength is a wavelength used for BD recording projected through a BD optics (92).

39. The method of writing information on an optical recording medium (38) according to claim 36, wherein the first wavelength is a wavelength used for BD recording projected through a BD optics (90), and the second wavelength is a wavelength used for DVD recording projected through a DVD optics (82).

40. The method of writing information on an optical recording medium (36) according to claim 36, wherein the first wavelength is a wavelength used for DVD recording projected through a DVD optics (86), and the second wavelength is a wavelength used for BD recording projected through a BD optics (90).

41. The method of writing information on an optical recording medium (38) according to claim 36, wherein the first wavelength is a wavelength used for BD recording projected through a BD optics (90), and the second wavelength is a wavelength used for HD-DVD recording projected through a HD-DVD optics (84).

42. The method of writing information on an optical recording medium (36) according to claim 36, wherein the first wavelength is a wavelength used for HD-DVD recording projected through a HD-DVD optics (88), and the second wavelength is a wavelength used for BD recording projected through a BD optics (90).

43. The method of writing information on an optical recording medium (12) according to claim 36, wherein the first wavelength is a wavelength used for DVD recording projected through a DVD optics (86), and the second wavelength is a wavelength used for DVD recording projected through a DVD optics (86).

44. The method of writing information on an optical recording medium (34) according to claim 36, wherein the first wavelength is a wavelength used for DVD recording projected through a DVD optics (86), and the second wavelength is a wavelength used for HD-DVD recording projected through a HD-DVD optics (88).

45. The method of writing information on an optical recording medium (34) according to claim 36, wherein the first wavelength is a wavelength used for HD-DVD recording projected through a HD-DVD optics (88), and the second wavelength is a wavelength used for DVD recording projected through a DVD optics (86).

46. The method of writing information on an optical recording medium (38) according to claim 36, wherein the first wavelength is a wavelength used for HD-DVD recording projected through a HD-DVD optics (88), and the second wavelength is a wavelength used for HD-DVD recording projected through a HD-DVD optics (88).

47. The method of writing information on an optical recording medium (20 to 26) according to claim 35, wherein the optical recording medium is illuminated from the same side when writing data on the data layer (40) and when writing visible information on the label layer (42).

48. The method of writing information on an optical recording medium (20) according to claim 47, wherein the first wavelength is a wavelength used for BD recording projected through a BD optics (92), and the second wavelength is a wavelength used for CD recording projected through a CD optics (94).

49. The method of writing information on an optical recording medium (24) according to claim 47, wherein the first wavelength is a wavelength used for DVD recording projected through a DVD optics (86), and the second wavelength is a wavelength used for BD recording projected through a BD optics (96).

50. The method of writing information on an optical recording medium (20) according to claim 47, wherein the first wavelength is a wavelength used for HD-DVD recording projected through a HD-DVD optics (92), and the second wavelength is a wavelength used for CD recording projected through a CD optics (94).

51. The method of writing information on an optical recording medium (24) according to claim 47, wherein the first wavelength is a wavelength used for DVD recording projected through a DVD optics (86), and the second wavelength is a wavelength used for HD-DVD recording projected through a HD-DVD optics (96).

52. The method of writing information on an optical recording medium according to claim 35, comprising the further steps of:
(a) providing an optical pickup unit (OPU) (98),
(b) using a wavelength used for BD recording as the first wavelength and a BD optics,
(c) using a wavelength used for CD recording as the second wavelength and a CD optics,
(d) positioning the OPU relative to the optical recording medium by using the first wavelength and a BD laser optics for determining the position of the OPU relative to the optical recording medium,
(e) turning on a laser beam having the second wavelength using the CD laser optics,
(f) writing a visible information item on the label layer by the laser beam having the second wavelength using the CD laser optics, and
(g) repeating steps (d) to (f) until a desired label has been written.

53. The method of writing information on an optical recording medium according to claim 52, wherein positioning of the OPU in step (d) comprises shifting the OPU.

54. The method of writing information on an optical recording medium according to claim 52, wherein positioning of the OPU in step (d) comprises tilting the OPU.

55. The method of writing information on an optical recording medium according to claim 52, wherein, after step (e), if the CD laser beam is not sufficiently focused, the OPU is re-positioned.

56. The method of writing information on an optical recording medium according to claim 52, wherein the positioning of the OPU in step (d) is performed such that in step (f) the CD laser spot is positioned adjacent an item of information written during a previous execution of step (f).

57. The method of writing information on an optical recording medium according to claim 35, wherein the writing of visible information on the label layer is performed by writing spiral tracks (100), the track pitch defining the optical contrast of the visible information.

58. An optical recording medium for being used in a method according to claim 35 having at least one data layer (40) for storing data readable by use of an optical readout device and at least one label layer (42) for storing visible information, wherein:
by focusing a first wavelength laser beam (44 to 58) onto the at least one data layer data is writable on the data layer, and
by focusing a second wavelength laser beam (60 to 78) onto the at least one label layer visible information is writable on the label layer, thereby a laser spot size being usable that is also employable when using the second wavelength laser beam for writing data on a data layer for storing data readable by use of an optical readout device, and
wherein the first wavelength is different from the second wavelength.

59. The optical recording medium according to claim 58, wherein the at least one data layer (40) and the at least one label layer (42) are covered by layers (102 to 132) that are transparent for the applied wavelengths, the layers having a thickness that allows focusing of the laser beams onto the data layer and onto the label layer to a spot size that is employable for writing data on a data layer for storing data readable by use of an optical readout device.

60. The optical recording medium according to claim 58, comprising the following sequence of layers:
a polycarbonate layer (134),
a label layer or label layer stack (136),
a data layer or data layer stack (138), and
a polycarbonate layer (140).

61. The optical recording medium according to claim 58, comprising the following sequence of layers:
a polycarbonate layer (134),
a label layer or label layer stack (136),
a thermal isolation layer (142),
a data layer or data layer stack (138), and
a polycarbonate layer (140).

62. The optical recording medium according to claim 58, comprising the following sequence of layers:
a polycarbonate layer (124),
a label layer or label layer stack (42),
a polycarbonate layer (156),
a data layer or data layer stack (40), and
a polycarbonate layer (122).

63. The optical recording medium according to claim 58, comprising the following sequence of layers:
a polycarbonate layer (144),
a label layer or label layer stack (146),
a polycarbonate layer (148),
a mirror layer (150) being selectively transparent for different wavelengths,
a data layer or data layer stack (152), and
a polycarbonate layer (154).

64. The optical recording medium according to claim 58, comprising the following sequence of layers:
a polycarbonate layer (158),
a data layer or data layer stack (160),
a polycarbonate layer (162),
a mirror layer (164) being selectively transparent for different wavelengths,
a label layer or label layer stack (166), and
a polycarbonate layer (168).

65. The optical recording medium according to claim 58, comprising the following sequence of layers:
a polycarbonate layer (170),
a label layer or label layer stack (172),
a bonding layer (174),
a data layer or data layer stack (176), and
a polycarbonate layer (178) having a groove structure.

66. A method of manufacturing an optical recording medium according to claim 58, comprising the steps of:
providing a first stack (170, 172) of a polycarbonate layer having a label layer or label layer stack on top of the polycarbonate layer,
providing a second stack (178, 176) of a grooved polycarbonate layer having a data layer or data layer stack on top of the grooved polycarbonate layer, and
bonding the first stack and the second stack together by providing a bonding layer (174) between the label layer and data layer, the label layer and data layer stack, the label layer stack and data layer or the label layer stack and data layer stack.
